(19) United States
(12) Patent Application Publication
(10) Pub. No.: US 2003/0194197 A1
(43) Pub. Date: Oct. 16, 2003

(54) Fiber array module and method for fabricating the same

(75) Inventors: Chung-I Chiang, Taoyuan (TW); Ming-Jen Wang, Tucheng City (TW); Kun-Hsien Cheng, Jungli City (TW); Hong-Jueng King, Taoyuan (TW); Huei-Pin Huang, Taoyuan (TW); Chwei-Jing Yeh, Sanchung City (TW)

Correspondence Address: BACON & THOMAS, PLLC, 625 SLATERS LANE, FOURTH FLOOR, ALEXANDRIA, VA, 22314

(73) Assignee: RiTek Corporation, Hsinchu (TW)

(21) Appl. No.: 10/411,259

(22) Filed: Apr. 11, 2003

(30) Foreign Application Priority Data
Apr. 12, 2002 (TW) 91107519

(51) Int. Cl. G02B 6/00

(52) U.S. Cl. 385/137

(57) ABSTRACT

A fiber array module is constructed by using low-temperature solders or metal as fastening means to fixedly secure optical fibers in grooves between a fiber array substrate and a top cover plate covered on the fiber array substrate over the optical fibers.

### BACKGROUND OF THE INVENTION

1. Field of the Invention

The present invention relates to modules for optical communication and, more particularly, to a fiber array module and the method for fabrication the same.

2. Description of Related Art

In recent years, optical fibers are intensively used as signal transmission media in optical communication. By matching with the development of high-channel-counts-plane-wave-guides and that of dense-wavelength-DeMux/Mutiplexer-DWDM, the communication through optical fibers can meet the demand for transmitting high-volume-data in high speed in internet communication and broadband communication. In most cases, plane-wave-guides of high channel counts containing at least a fiber array are commonly used or sandwiched between related photoelectric components for transmitting signals between those photoelectric components.

A conventional fiber array module generally comprises a fiber array substrate having a plurality of V-grooves for receiving and holding optical fibers and keeping loaded optical fibers in accurate aligned positions. According to conventional fiber array module fabrication methods, a binder is used to fix optical fibers to the respective grooves in the fiber array substrate by means of the application of a heat source or UV source. However, adequate binders for fastening the optical fibers and the substrate are limited. Due to the limited source scope of available binders for fastening and unstable quality of binders, a new and better structure of fiber array module or method for fabricating fiber array module is required.

### SUMMARY OF THE INVENTION

The present invention has been accomplished under the circumstances in view. It is therefore the main object of the present invention to provide a fiber array module and a method for fabricating the same, which is easy for mass-production, facilitates the assembling process, and create new source scope of the applying materials for fastening the optical fibers and the fibber array substrate, and greatly improves the yield.

It is another object of the present invention to provide a fiber array module, which has a strong structure resistant to impact.

To achieve these and other objects of the present invention, the fiber array module comprises a ribbon of optical fibers having a plurality of naked optical fibers at one end, wherein the peripheral surfaces said optical fibers of said ribbon are coated with a layer of metal coating and/or a layer of solders; a fiber array substrate having at least a plurality of fixing grooves on one surface adapting for said optical fibers of said ribbon respectively, wherein said surface with said grooves is coated with a layer of metal coating and/or solders; and a top cover plate for covering said fiber array substrate and sandwiching said optical fibers of said fiber array substrate, wherein said surface of said top cover plate is also coated with a layer of metal coating and/or solders.

The method for fabricating a fiber array module comprises following steps: providing a ribbon of optical fibers having a plurality of naked optical fibers at one end, a fiber array substrate having at least a plurality of fixing grooves on one surface adapting for said optical fibers of said ribbon respectively, and top cover plate for covering said fiber array substrate and sandwiching said optical fibers of said fiber array substrate; wherein said surface of said optical fibers, said surface of said grooves of said fiber array substrate and said surface of said top cover plate is coated with a layer of metal coating and/or solders; then mounting and aligning said optical fibers of said ribbon of optical fibers into said fixing grooves of said fiber array substrate respectively; and finally covering said top cover plate on said fiber array substrate to sandwich and to fasten said optical fibers of said ribbon of optical fibers in the fixing grooves of said fiber array substrate and keeping the layer of metal coating of said top cover plate in contact with the layer of metal coating and/or solders of said ribbon of optical fibers and the layer of metal and/or solders coating of said fiber array substrate, and then melting said layer of metal coating and/or solders of said top cover plate and the layer of metal coating and/or solders of said ribbon of optical fibers and the layer of metal coating and/or solders of said fiber array substrate through heat or radiation so as to fixedly fasten said top cover plate, said optical fibers of said ribbon of optical fibers and said fiber array substrate together.

Other objects, advantages, and novel features of the invention will become more apparent from the following detailed description when taken in conjunction with the accompanying drawings.

### BRIEF DESCRIPTION OF THE DRAWINGS

FIG. 1 illustrates a fiber array module constructed according to the prior art.

FIG. 2 illustrates a fiber array module constructed according to the present invention.

FIG. 3 is a cutaway view of the fiber array module shown in FIG. 2.

FIG. 4 is a cutaway view of the fiber array substrate according to the present invention.

### DETAILED DESCRIPTION OF THE PREFERRED EMBODIMENT

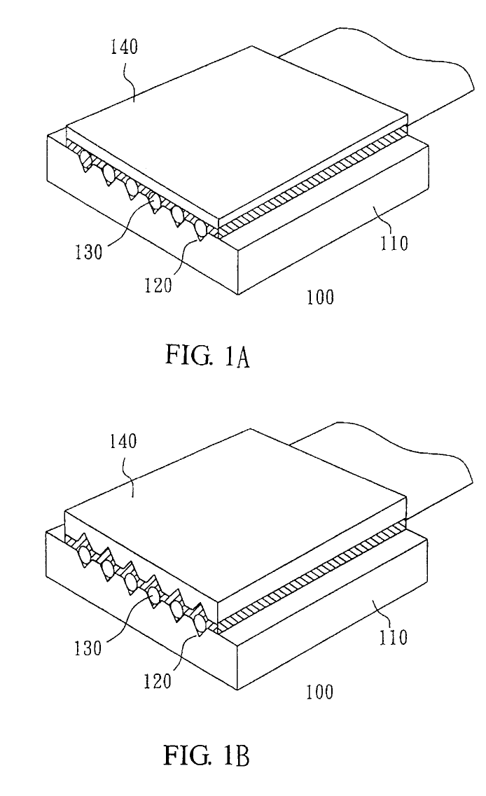

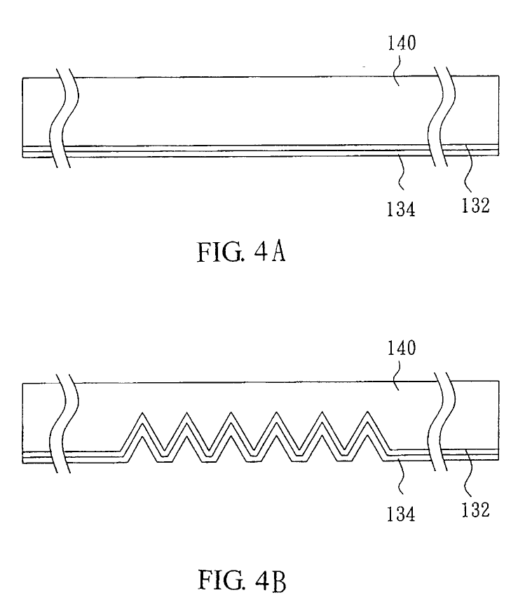

According to the present invention, the material for the fiber array substrate is not strictly limited. Preferably, the fiber array substrate is made of glass, silicon, or ceramics. The shape of the top cover plate is not strictly limited. For example, the top cover plate can be a plate having a planar bottom surface (see FIGS. 1A and 4A), or having auxiliary grooves in the bottom surface corresponding to the fixing grooves of the fiber array substrate to hold the respective optical fibers (see FIGS. 1B and 4B). The depth of the fixing grooves or the auxiliary grooves is not strictly limited. Preferably, the depth of the grooves or the auxiliary grooves is not less than the diameter of the optical fibers. The width of the fixing grooves or the auxiliary grooves is not strictly limited. Preferably, the width of the fixing grooves or the auxiliary grooves is not less than the diameter of the optical fibers. The shape of the fixing grooves or the auxiliary grooves is not strictly limited. For example, the fixing grooves or the auxiliary grooves can be made in a shape of a circular, semi-circular, “V” or “U”. Preferably, the fixing grooves or the auxiliary grooves have a V-shaped cross section. The arrangement of the fixing grooves or the auxiliary grooves is not strictly limited. The workable optical fibers are not strictly limited. The surface of the optical fibers of the ribbon of optical fibers is coated with a metal coating or solders. Preferably, the surface of the optical fibers of the ribbon of optical fibers is coated with a layer of metal and then coated with a layer of solder on the layer of metal. It means that the plated metal is sandwiched between the solder layer and the surface of the optical fibers. The surface of the fixing grooves of the fiber array substrate can be selectively coated with a layer of solder, or plated with a layer of metal. Preferably, the surface of the fixing grooves of the fiber array substrate is plated with a layer of metal and then coated with a layer of solder on the layer of metal. In other words, the plated metal is sandwiched between the solder layer and the surface of surface of the fixing grooves of the fiber array substrate. Likewise, the surface of the fiber array substrate can be selectively coated with a layer of solder, or plated with a layer of metal. Preferably, the surface of the fixing grooves of the fiber array substrate is plated with a layer of metal and then coated with a layer of solder on the layer of metal. In other words, the plated metal is sandwiched between the solder layer and the surface of surface of the fixing grooves of the fiber array substrate. The surface of the fiber array module may be selectively coated with a layer of metal coating. The surface of the top cover plate may be selectively coated with a layer of solder, or plated with a layer of metal. Preferably, the surface of the top cover plate is plated with a layer of metal and then coated with a layer of solder on the layer of metal. In other words, the plated metal is sandwiched between the solder layer and the surface of the top cover plate. Furthermore, the fixing grooves are preferably arranged in parallel.

With reference to FIGS. 1A and 1B, a fiber array module 100 in accordance with the present invention is shown comprising a fiber array substrate 110, a ribbon of optical fibers 130, and a top cover plate 140. The fiber array substrate 110 has a plurality of fixing grooves 120 arranged in parallel in the top sidewall thereof and adapted for holding optical fibers 130. The fixing grooves 120 may be variously shaped. According to this embodiment, the Fgrooves 120 are V-grooves. The size of the fixing grooves 120 is not limited. According to this embodiment, the depth and width of the fixing V-grooves 120 are sufficient to receive the optical fibers 130 completely.

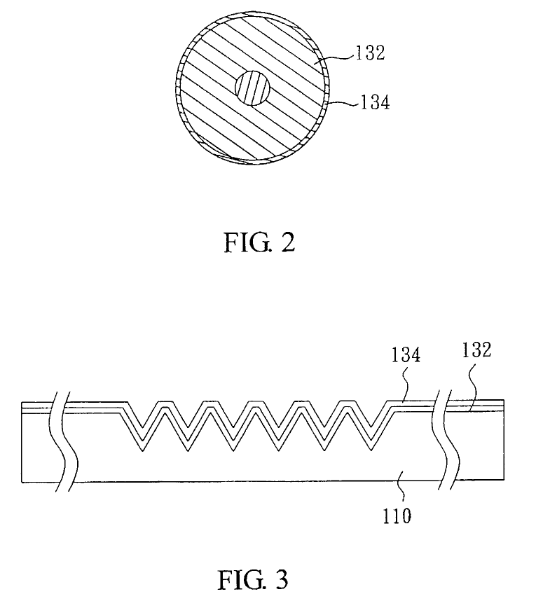

Referring to FIGS. 2, 3, 4A and 4B, the outer layer 132 of each optical fibers 130 is coated with a layer of metal coating and then coated with a layer of solder of thickness ranging from 1 μm to 5 μm (see FIG. 2). Similar to the coatings of the optical fibers 130, the surface of the fixing V-grooves 120 is coated with a layer of metal coating and then coated with a layer of solder (see FIG. 3). The bottom sidewall of the top cover plate 140 can be a planar surface (see FIG. 1A) or grooved corresponding to the fixing V-grooves 120 of the fiber array substrate 110 (see FIG. 1B). Before covering the top cover plate 140 on the fiber array substrate 110 to hold down the optical fibers 130 in the fixing V-grooves 120, the bottom sidewall of the top cover plate 140 is coated with a layer of metal coating and then a layer of solder. The metal coating can be Ni/Au, nickel, or gold. The solder can be Pb/Sn.

After coating, the optical fibers 130 are put into the fixing V-grooves 120 of the fiber array substrate 110, and then the top cover plate 140 is covered on the fiber array substrate 110 to hold down the optical fibers 130 in the fixing V-grooves 120, and then a heat source or a radiation (e.g. UV light) is applied to melt the coating of solder at the optical fibers 120, the fiber array substrate 110 and the top cover plate 140, thereby causing the top cover plate 140, the optical fibers 130 and the fiber array substrate 110 to be fixedly secured together.

As indicated above, the invention uses solder as fastening means to fixedly secure the top cover plate, the optical fibers and the fiber array substrate together. This method is economic, and suitable for mass production. A fiber array module made according to this method is highly reliable at high temperature.

Although the present invention has been explained in relation to its preferred embodiment, it is to be understood that many other possible modifications and variations can be made without departing from the spirit and scope of the invention as hereinafter claimed.

What is claimed is:

1. A fiber array module comprising:
a ribbon of optical fibers having a plurality of naked optical fibers at one end, wherein the peripheral surfaces said optical fibers of said ribbon are coated with a layer of metal coating and/or a layer of solders;
a fiber array substrate having at least a plurality of fixing grooves on one surface adapting for said optical fibers of said ribbon respectively, wherein said surface with said grooves is coated with a layer of metal coating and/or solders; and
a top cover plate for covering said fiber array substrate and sandwiching said optical fibers of said fiber array substrate, wherein said surface of said top cover plate is also coated with a layer of metal coating and/or solders.

2. The fiber array module as claimed in claim 1, wherein said top cover plate has a plurality of auxiliary grooves for covering and sandwiching said corresponding optical fibers of said fiber array substrate.

3. The fiber array module as claimed in claim 1, wherein said fixing grooves of said fiber array substrate are V-grooves.

4. The fiber array module as claimed in claim 1, wherein the depth of said fixing grooves of said fiber array substrate is not less than the diameter of the optical fibers of said ribbon of optical fibers.

5. The fiber array module as claimed in claim 1, wherein said peripheral surface of said optical fibers of said ribbon of optical fibers is coated with a base layer of metal and a covering layer of solders, and said base layer of metal is sandwiched between said covering layer of solders and said surface of said optical fibers.

6. The fiber array module as claimed in claim 1, wherein said surface of said fixing grooves of said fiber array substrate is coated with a layer of metal coating and a layer of solders, and said base layer of metal is sandwiched between said covering layer of solders and said surface of said fixing grooves of said fiber array substrate.

7. The fiber array module as claimed in claim 1, wherein said metal is Ni/Au, electro less-plated Ni or gold.

8. The fiber array module as claimed in claim 1, wherein said solder is gold or Pb/Sn.

9. The fiber array module as claimed in claim 1, wherein the layer of metal coating and/or solders of said top cover plate are a base layer of metal and a layer of solder covering the base layer of metal, and said base layer of metal is sandwiched between said layer of said solders and said surface of said top cover plate.

10. The fiber array module as claimed in claim 1, wherein said fixing grooves of said fiber array substrate are arranged in parallel.

11. A method for fabricating a fiber array module comprising the steps of:
(A) providing a ribbon of optical fibers having a plurality of naked optical fibers at one end, a fiber array substrate having at least a plurality of fixing grooves on one surface adapting for said optical fibers of said ribbon respectively, and top cover plate for covering said fiber array substrate and sandwiching said optical fibers of said fiber array substrate; wherein said surface of said optical fibers, said surface of said grooves of said fiber array substrate and said surface of said top cover plate is coated with a layer of metal coating and/or solders;
(B) mounting and aligning said optical fibers of said ribbon of optical fibers into said fixing grooves of said fiber array substrate respectively; and
(C) covering said top cover plate on said fiber array substrate to sandwich and to fasten said optical fibers of said ribbon of optical fibers in the fixing grooves of said fiber array substrate and keeping the layer of metal coating of said top cover plate in contact with the layer of metal coating and/or solders of said ribbon of optical fibers and the layer of metal and/or solders coating of said fiber array substrate, and then melting said layer of metal coating and/or solders of said top cover plate and the layer of metal coating and/or solders of said ribbon of optical fibers and the layer of metal coating and/or solders of said fiber array substrate through heat or radiation so as to fixedly fasten said top cover plate, said optical fibers of said ribbon of optical fibers and said fiber array substrate together.

12. The method as claimed in claim 11, wherein said top cover plate has a plurality of auxiliary grooves for covering and sandwiching said corresponding optical fibers of said fiber array substrate.

13. The method as claimed in claim 11, wherein the fixing grooves of said fiber array substrate are V-grooves.

14. The method as claimed in claim 11, wherein the depth of said fixing grooves of said fiber array substrate is not less than the diameter of the optical fibers of said ribbon of optical fibers.

15. The fiber array module fabrication method as claimed in claim 11, wherein said peripheral surface of said optical fibers of said ribbon of optical fibers is coated with a base layer of metal and a covering layer of solders, and said base layer of metal is sandwiched between said covering layer of solders and said surface of said optical fibers.

16. The method as claimed in claim 11, wherein said surface of said fixing grooves of said fiber array substrate is coated with a layer of metal coating and a layer of solders, and said base layer of metal is sandwiched between said covering layer of solders and said surface of said fixing grooves of said fiber array substrate.

17. The method as claimed in claim 11, said metal is Ni/Au, electro less-plated Ni or gold.

18. The method as claimed in claim 11, wherein said solder is gold or Pb/Sn.

19. The method as claimed in claim 11, wherein the layer of metal coating and/or solders of said top cover plate are a base layer of metal and a layer of solder covering the base layer of metal, and said base layer of metal is sandwiched between said layer of said solders and said surface of said top cover plate.

20. The method as claimed in claim 11, wherein said fixing grooves of said fiber array substrate are arranged in parallel.
